(19) United States
(12) Patent Application Publication
(10) Pub. No.: US 2012/0193572 A1
(43) Pub. Date: Aug. 2, 2012

(54) BEDDING PRODUCT HAVING PHASE CHANGE MATERIAL

(75) Inventor: Walter MacKay, Tupelo, MS (US)

(73) Assignee: SLEEP INNOVATIONS, INC., West Long Branch, NJ (US)

(21) Appl. No.: 13/363,876

(22) Filed: Feb. 1, 2012

Related U.S. Application Data
(60) Provisional application No. 61/438,467, filed on Feb. 1, 2011.

(51) Int. Cl. C09K 5/06; B29C 39/02

(52) U.S. Cl. 252/78.1; 252/71; 252/77; 252/73; 252/79; 264/299

(57) ABSTRACT

Embodiments herein describe a cooling cushion or bedding product and methods of making the same. In some embodiments, the cooling cushion or bedding product comprises a microencapsulated phase change material having a melting point in the range from about −30° C. to about 55° C. and a foam. In some embodiments, the microencapsulated phase change material is uniformly dispersed within the foam. Embodiments herein also describe a method of making a cooling cushion or bedding product comprising dispersing a microencapsulated phase change material into a polyol to create a polyol-PCM blend and adding an isocyanate to the polyol-PCM blend. Some embodiments describe a method of making a cooling cushion or bedding product comprising pouring polyol, microencapsulated phase change material having a melting point in the range from about −30° C. to about 55° C. and isocyanate together to form a foaming reaction.

### CROSS-REFERENCE TO RELATED APPLICATIONS

This application claims the benefit of and priority from U.S. Patent Application No. 61/438,467 filed Feb. 1, 2011, the contents of which is incorporated by reference herein in its entirety.

### BACKGROUND

Phase change is a term used to describe a process in which a solid turns to liquid or gas. The process of phase change from a solid to a liquid requires energy to be absorbed by the solid. When a phase change material (“PCM”) liquefies, energy is absorbed from the immediate environment as it changes from solid to liquid. In contrast to a sensible heat storage material which absorbs and releases energy essentially uniformly over a broad temperature range, a phase change material absorbs and releases a large quantity of energy in the vicinity of its melting/freezing point. Therefore, a PCM that melts below body temperature would feel cool as it absorbs heat, for example, from a body. Phase change materials, therefore, include materials that liquefy (melt) to absorb heat and solidify (freeze) to release heat. The melting and freezing of the material takes place over a narrow temperature range.

PCMs have been used in various applications ranging from household insulation to clothing. Widespread use of direct incorporation of phase change materials into polyurethane foam, however, has not been achieved because the phase change material adversely affects the physical properties of the foam. Direct incorporation of phase change materials into flexible open cell polyurethane foam reduces the foam's strength properties and the foam's physical properties by affecting the exothermic reaction necessary for foam formation. Therefore, present incorporation of phase change materials into polyurethane foams include dispersal of phase change materials on thin pre-formed foams. Dispersal in pre-formed foams is expensive, involves an additional step after formation of the foam, and does not uniformly distribute the phase change materials through out flexible open cell polyurethane over one inch in thickness.

Accordingly, there exists a need for a method to obtain the benefits of phase change materials in bedding products without treating the foam post-formation. It is further desired to provide bedding products with a uniform and consistent distribution of PCM that is cost effective and easy to manufacture in a one step process.

### SUMMARY

Embodiments herein describe a cooling cushion and methods of making the same. In embodiments, a cooling cushion comprises a phase change material having a melting point in the range from about −30° C. to about 55° C. and a foam, wherein the phase change material is dispersed within the foam. In some embodiments, the phase change material is microencapsulated. In some embodiments, the foam comprises viscoelastic foam, polyurethane foam, memory foam, slow recovery foam, ground foam, latex foam, reflex foam, continuous foam, hyper-soft resilient foam, hyper-soft high airflow viscoelastic foam or a combination thereof. In some embodiments, the phase change material comprises a halogenated paraffin having 10 to 22 carbon atoms, 2,2-dimethyl-1,3-propanediol, 2-hydroxymethyl-2-methyl-1,3-propanediol, eicosanic acid, methyl palmitate, fatty alcohols or a combination thereof. In some embodiments, the phase change material may be mono- or poly-, chlorinated or brominated paraffin such as, for example, bromooctadecane, bromopentadecane, bromononodecane, bromoeicosane, bromodocosane. In some embodiments, the phase change material may be dispersed throughout the foam.

Embodiments describe a bedding product comprising a phase change material having a melting point in the range from about −30° C. to about 55° C. and a foam, wherein the phase change material is dispersed within the foam. In some embodiments, the phase change material may be microencapsulated. In some embodiments, the foam may comprise viscoelastic foam, polyurethane foam, memory foam, slow recovery foam, ground foam, latex foam, reflex foam, continuous foam, hyper-soft resilient foam, hyper-soft high airflow viscoelastic foam or a combination thereof. In some embodiments, the phase change material comprises a halogenated paraffin having 10 to 22 carbon atoms, 2,2-dimethyl-1,3-propanediol, 2-hydroxymethyl-2-methyl-1,3-propanediol, eicosanic acid, methyl palmitate, fatty acid ester, fatty alcohols or a combination thereof. In some embodiments, the phase change material may be a mono- or poly-, chlorinated or brominated paraffin such as, for example, bromooctadecane, bromopentadecane, bromononodecane, bromoeicosane, bromodocosane. In some embodiments, the phase change material may be dispersed throughout the foam.

Embodiments describe a method of making a cooling cushion comprising dispersing a phase change material having a melting point in the range from about −30° C. to about 55° C. into a polyol to create a polyol-PCM blend and adding an isocyanate to the polyol-PCM blend to form a viscous mixture. In some embodiments, the method further comprises mixing additives into the polyol-PCM blend. In some embodiments, the additive may be an activator, a catalyst, a stabilizer, a colorant, a dye, a pigment, a chain-extending agent, a surfactant, a filler, a blowing agent, or a combination thereof. In some embodiments, the method further comprises curing the viscous mixture to form a foam. In some embodiments, the method further comprises pouring the viscous mixture into an open mold.

Embodiments describe a method of making a cooling cushion comprising reacting a polyol and a phase change material having a melting point in the range from about −30° C. to about 55° C. with an isocyanate. Some embodiments describe a method of making a cooling cushion comprising continuously pouring polyol, phase change material having a melting point in the range from about −30° C. to about 55° C. and isocyanate together to form a foaming reaction. In some embodiments, a method of making a cooling cushion comprises mixing a polyol, a phase change material and an isocyanate to form a foaming reaction.

Embodiments describe a method of making a bedding product comprising reacting a polyol and a phase change material having a melting point in the range from about −30° C. to about 55° C. with an isocyanate. Some embodiments describe a method of making a bedding product comprising dispersing a phase change material having a melting point in the range from about −30° C. to about 55° C. in a polyol to create a polyl-PCM blend and reacting the polyol-PCM blend with an isocyanate to form a viscous mixture.

### DESCRIPTION OF DRAWINGS

For a fuller understanding of the nature and advantages of the present invention, reference should be had to the following detailed description taken in connection with the accompanying drawings, in which:

FIG. 1 illustrates a cooling cushion according to an embodiment described herein.

FIG. 2 illustrates a method of making a cooling cushion according to an embodiment described herein.

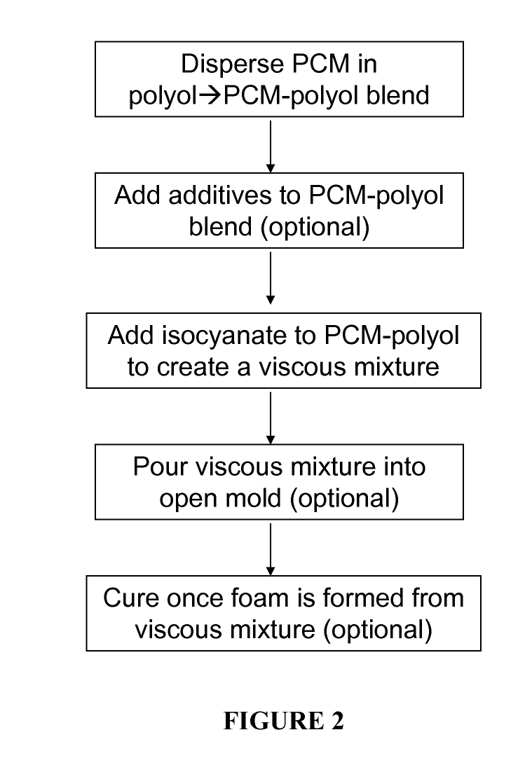

FIG. 3 illustrates a method of making a cooling cushion according to an embodiment of a “one shot” process described herein.

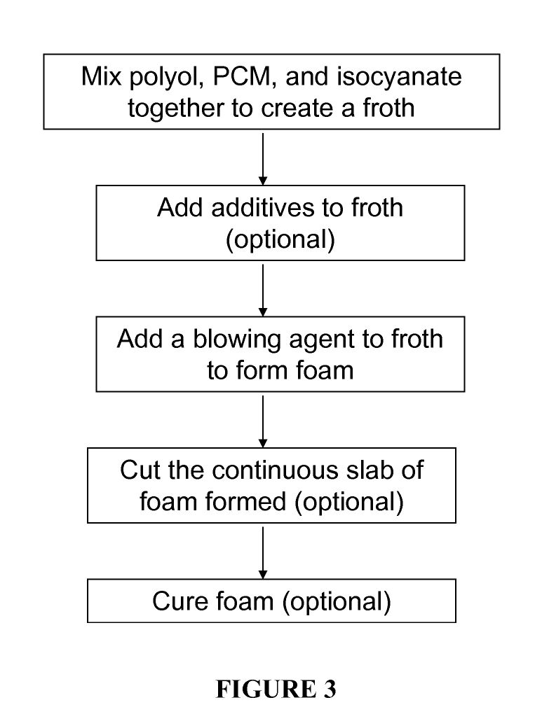

### DETAILED DESCRIPTION

This invention is not limited to the particular processes, compositions, or methodologies described, as these may vary. The terminology used in the description is for the purpose of describing the particular versions or embodiments only, and is not intended to limit the scope of the present invention. Unless defined otherwise, all technical and scientific terms used herein have the same meanings as commonly understood by one of ordinary skill in the art. All publications mentioned herein are incorporated by reference in their entirety. Nothing herein is to be construed as an admission that the invention is not entitled to antedate such disclosure by virtue of prior invention.

As used herein and in the appended claims, the singular forms “a”, “an”, and “the” include plural references unless the context clearly dictates otherwise. Thus, for example, reference to a “phase change material” or “PCM” is a reference to one or more phase change materials and equivalents thereof known to those skilled in the art, and so forth.

As used herein, the term “about” means plus or minus 10% of the numerical value of the number with which it is being used. Therefore, about 50% means in the range of 45%-55%.

As used in this document, the term “comprises” means includes at least the following but does not exclude others.

As used in this document, the term “bedding product” includes, without limitation, mattresses, pillows, mattress toppers, seat cushions and any product intended to cushion and support at least part of a person. It also includes like items made of memory foam such as that used in mattresses and pillows, such as lumbar supports, back supports, gaming chairs, ottomans, chair pads, benches and seats.

As used herein, the term “cooling cushion” may encompass any foam product comprising phase change materials.

As used herein, the term “room temperature” refers to an indoor temperature of from about 20° C. to about 25° C. (about 68° F. to about 77° F.).

As used herein, the term “body temperature” refers to a typical human skin temperature of from about 30° C. to about 39° C. In some embodiments, body temperature means a skin temperature of from about 32° C. to about 37° C.

The term “foam,” as used herein, means any type of air filled matrix structure including without limitation viscoelastic foam, polyurethane foam, memory foam, slow recovery foam, ground foam, latex foam, reflex foam, continuous foam, hyper-soft resilient foam, hyper-soft high airflow viscoelastic foam or combinations thereof. In some embodiments, the foam may be a polyurethane foam. In particular embodiments, the foam may be a polyurethane foam created from a formulation comprising an isocyanate, a surfactant, and a polyol. Polyurethane foam is currently utilized by many industries such as furniture, construction, transportation, insulation, medical, and packaging and is commonly used as cushioning material in upholstered furnishings, mattresses, and airline and automobile seating.

In some embodiments, the polyol of the polyurethane foam may comprise a polyol blend comprising a vegetable oil polyol as described in U.S. Pat. No. 7,700,661, which is hereby incorporated by reference. In further embodiments, the polyurethane foam may be made from a formulation comprising a polyol blend including a petrochemical polyol and a vegetable oil polyol, and an isocyanate blend comprising a 2, 4 toluene diisocyanate (TDI) isomer and a 2, 6 TDI isomer, wherein the ratio of petrochemical polyol to vegetable oil polyol in the polyol blend is about equal to the ratio of the 2, 4 TDI isomer to the 2, 6 TDI isomer in the isocyanate blend, as described in the '661 patent. In some embodiments, the foam may further include additives such as, without limitation, activators, stabilizers, amines, colorants, dyes, pigments, blowing agents, chain-extending agents, surface-active agents (i.e., surfactants), fillers, and the like.

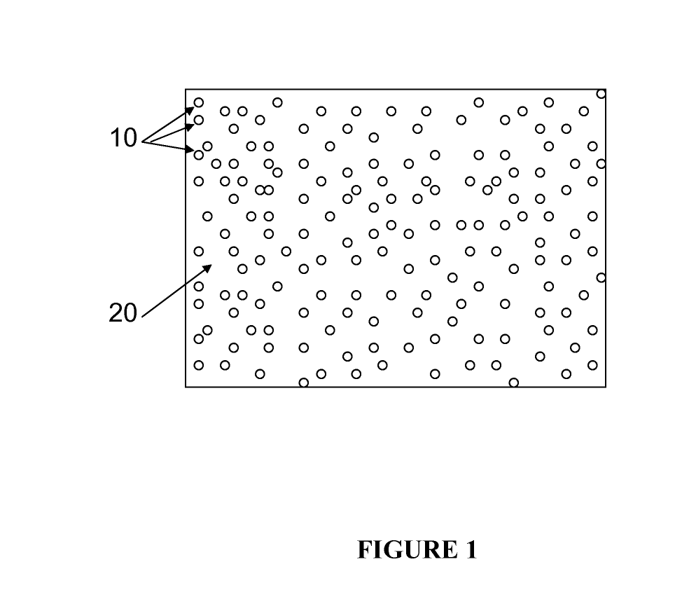

Referring to FIG. 1, embodiments herein describe a cooling foam comprising foam 20 and a PCM 10. In further embodiments, the foam 20 may be polyurethane foam. In some embodiments, the PCM 10 is dispersed in the foam 20. In some embodiments, the PCM 10 is dispersed in a portion of the foam 20. In some embodiments, the PCM 10 may be dispersed evenly throughout the foam 20. In some embodiments, the PCM 10 may be dispersed in selected areas of the foam 20. In some embodiments, the PCM 10 is particulated and dispersed within the foam 20. Further embodiments include bedding products, as defined above, comprising foam 20 and a PCM 10.

Without wishing to be bound by theory, it is believed that bedding products comprising foam 20 and a PCM 10 having a melting point below body temperature would help reduce the problem of pillows and mattresses overheating while in use and would improve comfort.

In some embodiments, PCM 10 of embodiments herein may have a melting point below body temperature. In some embodiments, the PCM 10 of embodiments herein may have a melting point from about −30° C. to about 55° C. In other embodiments, the melting point of the PCM 10 may be in the range of from about 0° C. to about 40° C., from about 15° C. to about 40° C., from about 25° C. to about 40° C., or from about 25° C. to about 36° C. In some embodiments, the melting point of the PCM 10 may be about 25° C., about 26° C., about 27° C., about 28° C., about 29° C., about 30° C., about 31° C., about 32° C., about 33° C., about 34° C., about 35° C., about 36° C., or about 37° C.

Examples of PCM 10 that may be used in aspects of the invention include, without limitation, PCMs disclosed in U.S. Pat. No. 5,435,376, U.S. Pat. No. 5,007,478, U.S. Pat. No. 5,106,520, U.S. Pat. No. 4,911,232, U.S. Pat. No. 4,756,958, U.S. Pat. No. 4,513,053, U.S. Pat. No. 5,415,222, or U.S. Pat. No. 5,290,904, each of which is hereby incorporated by reference. In embodiments, the PCM 10 may comprise any hydrophobic PCM. In some embodiments, the PCM 10 may be any hydrophobic PCM which can be dispersed in water and microencapsulated. In some embodiments, the PCM 10 may comprise a wax. In some embodiments, the PCM may comprise paraffin. In further embodiments, the PCM may be a halogenated paraffin. In some embodiments, the paraffin may be a mono-chlorinated paraffin, a poly-chlorinated paraffin, a mono-brominated paraffin or a poly-brominated paraffin such as that disclosed in U.S. Pat. No. 5,435,376, which is hereby incorporated by reference. In embodiments, the PCM 10 comprises, without limitation, paraffinic hydrocarbons having 13 to 28 carbon atoms. In other embodiments, the PCM 10 may comprise crystalline materials such as 2,2-dimethyl-1,3-propanediol, 2-hydroxymethyl-2-methyl-1,3-propanediol, acids of straight or branched chain hydrocarbons such as eicosanic acid and esters such as methyl palmitate, or fatty alcohols. In some embodiments, various phase change materials may be mixed to obtain the desired temperature range for phase change.

In some embodiments, the PCM may be present in an amount from about 1 to about 100 php (parts per hundred polyol by weight), from about 5 to about 100 php or from about 10 to about 100 php. In some embodiments, the PCM may be dispersed throughout the foam in an amount of up to about 50% by weight of the foam. In some embodiments, the PCM may be dispersed in an amount up to about 40%, up to about 30%, up to about 25%, up to about 20%, up to about 10%, from about 5% to about 50%, from about 5% to about 40%, from about 5% to about 30%, from about 5% to about 25%, from about 5% to about 20%, from about 5% to about 10%, or from about 7% to about 10% by weight of the foam. In certain embodiments, for example, the cooling cushion may comprise 20 pounds of PCM for every 100 pounds of PCM-containing foam. In certain embodiments, for example, the cooling cushion may comprise 10 pounds of PCM for every 100 pounds of PCM-containing foam.

In some embodiments, the PCM may be encapsulated. In some embodiments, the encapsulation may be microencapsulation or macroencapsulation. In some embodiments, the encapsulation may be microencapsulation. As used herein, “encapsulation” refers to a process in which particles or droplets of phase change material are surrounded by a coating. In some embodiments, the phase change material may be surrounded by multiple coating layers. Examples of methods of encapsulating a PCM may be found in U.S. Pat. No. 4,504,402, U.S. Pat. No. 4,708,812, U.S. Pat. No. 5,435,376, U.S. Pub. No. 2008/0193653, or U.S. Pub. No. 2011/0008536, each of which is hereby incorporated by reference. It is believed that encapsulation avoids the problem of phase change materials having an adverse effect on foam formation by forming a shell around the phase change material and shielding the exothermic reaction required for foam formation from being affected by the phase change material.

In some embodiments, the PCM may be microencapsulated. In some embodiments, the largest dimension of a microencapsulated PCM may be from about 1 to about 1000 microns, from about 1 to about 500 microns, from about 1 to about 100 microns, from about 2 to 50 microns, from about 1 to about 20 microns, from about 5 to about 20 microns, from about 10 to about 20 microns, or from about 15 to about 20 microns. In some embodiments, the microencapsulated PCM is spherical and the largest dimension is the diameter.

In some embodiments, the PCM may be macroencapsulated. In some embodiments, the largest dimension of a macroencapsulated PCM may be from about 1 mm to about 10 mm, from about 2 mm to about 10 mm, from about 2 mm to about 8 mm, or from about 3 mm to about 5 mm.

In some embodiments, the capsule wall may comprise a polymer or plastic. In some embodiments, the capsule wall may comprise an inert, stable polymer. In some embodiments, the capsule wall may comprise a plastic. In some embodiments, the plastic is a thermosetting plastic. In some embodiments, the thermosetting plastic may comprise vulcanized rubber, phenol formaldehyde, melamine formaldehyde, urea formaldehyde, epoxy resin, melamine resin, polyimides, cyanate esters, polycyanurates, acrylic plastics, methyl metacrylate, or urea-resorcinol formaldehyde. In some embodiments, the capsule wall may comprise a plastic selected from high density polyethylene, low density polyethylene, polyethylene terephthalate, and polypropylene. In some embodiments, the encapsulated PCMs may be a dry powder.

Other exemplary compositions used for encapsulating the PCM may comprise polyol, fabric, elastomers, thermoplastic materials, or the like. Suitable thermoplastic materials of embodiments include soft polyvinyl chloride, nylon, polypropylene, polyethylene, fluoropolymers, urethane, copolymers of polyvinyl chloride and vinyl acetate, silicon rubber, and mixtures of polyvinyl chloride and synthetic rubber. The thermoplastic material may also be composed of a composite, such as a woven nylon material with a protective coating of urethane or vinyl. Suitable elastomers include poly(ethylene/butylene), hydrogenated poly(isoprene), hydrogenated poly(butadiene), hydrogenated poly(isoprene+butadiene), poly(ethylene/propylene), hydrogenated poly(ethylene/butylene+ethylene/propylene), polyurethane, polyisoprene, polybutadiene, or the like. In some embodiments, microencapsulating a PCM comprises dispersing droplets of the molten PCM in an aqueous solution and forming walls around the droplets using techniques such as coacervation, interfacial polymerization or in situ polymerization all of which are well known in the art. For example, the methods are well known in the art to form gelatin capsules by coacervation, polyurethane or polyurea capsules by interfacial polymerization, and urea-formaldehyde, urea-resorcinol-formaldehyde, and melamine formaldehyde capsules by in situ polymerization. In some embodiments, the PCMs are encapsulated using melamine-formaldehyde.

In some embodiments, the PCM 10 further comprises an additive. In further embodiments, the additive may be a plasticizer, a melt viscosity modifier, a tensile strength modifier, a shrinkage reducer, a plasticizer bleed modifier, a tack modifier, a foam facilitator, a flame retardant, or mixtures thereof. Examples of useful, inherently flame retardant, PCMs include a halogenated paraffin having 10 to 22 carbon atoms and, more specifically, a mono or poly-chlorinated or brominated paraffin such as bromooctadecane, bromopentadecane, bromononodecane, bromoeicosane, bromodocosane, etc. Examples of flame retardants which may be used in admixture with PCMs include decabromodiphenyl oxide, octabromodiphenyl oxide, antimony oxide, etc. In embodiments, additive flame retardants may be used in an amount of about 3 to 20 parts per 100 parts PCM. For example, the incorporation of an inherently flame retardant encapsulated PCM or an encapsulated PCM containing a flame retardant into otherwise flammable substrates, such as polyurethane foam, imparts a flame retardant characteristic to the foam 20 in addition to the phase change characteristic.

Without wishing to be bound by theory, the addition of a flame retardant additive to the PCM may also enhance the PCM's thermal efficiencies and narrow the temperature range over which the phase change occurs. The additive appears to function as a nucleating agent and cause the PCM to change phase at a faster rate and over a narrower temperature range. We have found that the addition of the flame retardant additive is useful in tailoring the thermal transfer characteristics of the PCM and can be particularly advantageous where a narrow transition temperature range is desired.

Embodiments herein also describe methods of making a cooling cushion comprising dispersing a PCM 10 in polyol to make a polyol-PCM blend and adding isocyanate to the polyol-PCM blend to create a viscous mixture. In some embodiments, the method further comprises adding additives to the polyol-PCM blend. In some embodiments, the additives are added to the viscous mixture. In some embodiments, the method further comprises pouring the viscous mixture into an open mold. In some embodiments, the open mold is lined with polypropylene. In some embodiments, the polyol is not pre-cured or pre-formed before the PCM is dispersed into the polyol. Thus, the viscous mixture is cured once a foam has formed after the viscous mixture is placed into the mold. In some embodiments, the PCM 10 is macroencapsulated before being dispersed with the polyol. In some embodiments, the PCM 10 is microencapsulated. In some embodiments, the polyol is a polyol blend.

In some embodiments, the foam 20 is a flexible polyurethane foam. Typically, flexible polyurethane foam is manufactured in slab stock form in what is often referred to as a “one shot” process. The process involves the continuous pouring of mixed liquids such as a polyol and isocyanate onto a conveyor where it reacts into a froth creating a continuous loaf of foam. Water or other chemical additives can be used as blowing agents that turn into gas bubbles upon reaction, quickly expanding the froth to form a large “bun” or “slab” of partially polymerized polyurethane foam. Once the foam is fully expanded, the polymerization progresses in seconds to reach a fully cross-linked, solid state. The continuous slab is then cut, allowed to cool or “cure”, and stored. Methods to manufacture polyurethane foams are well known to one skilled in the art, however, resultant foam product quality remains a function of the chemical composition and manufacturing procedures, and both are continually reviewed for improvements to the final product. In embodiments herein, a method of making a cooling cushion comprises dispersing a PCM 10 into a polyol before the polyol is mixed with the isocyanate in the “one shot” process. In some embodiments, a method of making a cooling cushion comprises adding a PCM 10 to the polyol and isocyanate as it is mixing. In some embodiments, the polyol, isocyanate and PCM 10 are poured simultaneously onto the conveyor. In some embodiments, a PCM 10 may be added anytime before the frothing process. In some embodiments, the PCM is macroencapsulated. In some embodiments, the PCM is microencapsulated.

The polyol used in embodiments herein may be any suitable polyol for use in a reaction to form foam and may be a conventional polyol, a grafted polyol, or combinations thereof. As used in this document, the term polyol is intended to include any type of polyol such as diol, triol, tetrol, polyol, and blends of any of these materials. In an embodiment, the polyol may be a polyester polyol, polyether polyol or combinations thereof. Examples of suitable polyols include ethylene glycol, propylene glycol, butylene glycol, hexanediol, octanediol, neopentyl glycol, 1,4-bishydroxymethyl cyclohexane, 2-methyl-1,3-propane 10 diol, glycerin, trimethylolethane, hexanetriol, butanetriol, quinol, polyester, methyl glucoside, triethylene glycol, tetraethylene glycol, polyethylene glycol, dipropylene glycol, polypropylene glycol, diethylene glycol, glycerol, pentaerythritol, trimethylolpropane, sorbitol, mannitol, dibutylene glycol, polybutylene glycol, alkylene glycol, oxyalkylene glycol, diethylene glycol, dipropylene glycol, triethylene glycol, tripropylene glycol, tetraethylene glycol, tetrapropylene glycol, trimethylene glycol, tetramethylene glycol, 1,4-cyclohexanedimethanol (1,4-bis-hydroxymethylcyclohexane), vegetable oil polyol, or mixtures thereof.

Specific examples of suitable polyols include polyol SP-170, polyol SP-2744, polyol SP-370, and polyol SP-238, each available from Peterson Chemical Technology, Pluracol 2100 and Pluracol 2130, both available from BASF Corporation, and Voranol 3136 and Voranol 3943A, available from Dow Chemical Company. Pluracol polyol 2100 is a primary terminated conventional triol and contains a LVI inhibitor package. Pluracol polyol 2130 is a primary hydroxyl-terminated graft poyether triol containing approximately 31% solids of copolymerized styrene and acrylonitrile, utilizing a LVI inhibitor package. Voranol 3136 polyether polyol is a general purpose, nominal 3100 molecular weight, heteropolymer triol. Voranol 3943A copolymer polyol is a grafted polyol containing high levels of copolymerized styrene and acrylonitrile. It forms stable dispersions that will not separate under normal conditions. In one embodiments, the polyol may comprise a polyol blend comprising polyol SP-170 in an amount from about 40 to about 80 php, polyol SP-2744 from about 10 to about 30 php, polyol SP-370 in an amount from about 0.2 to about 5.0 php, polyol SP-238 in an amount from 2.0 to 20.0 php or combinations thereof.

Examples of other suitable polyols include Pluracol 994 and Pluracol 1385 by BASF Corporation; Voranol CP3322 and Voranol 3010 by Dow Chemical Company; SP-168, SP-170, SP-238 and SP-2744 from Peterson Chemical Supply LLC; Arcol 1131, Arcol 3020, and Arcol 3010 by Bayer Chemicals; and Caradol SC46-02 and Caradol SC56-02 by Shell Chemicals; plant based polyols such as BiOH polyols made from soybean oil, available from Cargill Industrial Bio-Products; and any other like polyols. In an embodiment, polyols known as Voranol 3943A, Voranol HL-400, and Voranol HL-430, all by Dow Chemical Company, (or any other polyol medium containing an acrylonitrile/styrene graft polymer dispersed therein) are not used as the sole polyol component in the foam formulation. In other words, for this embodiment when using a polyol having an acrylonitrile/styrene graft polymer dispersed therein, a second polyol that does not contain acrylonitrile/styrene graft polymer may be combined therewith to form a polyol mixture.

The isocyanate of embodiments herein may be any suitable isocyanate for use in a reaction to form polyurethane foam, and in an embodiment the isocyanate may be toluene diisocyanate (TDI). Preferably, the TDI comprises an isomeric blend of 80/20 weight ratio or a 65/35 weight: ratio of 2,4 isomer/2,6 isomer. Examples of suitable 80/20 TDI blends are Lupranate T80 available from BASF Corporation and Voranate T-80 available from Dow Chemical, specification sheets for which are included in Tables 7-10 below. Lupranate® T80 toluene diisocyanate (TDI) is an 80/20 mixture of the 2,4 and 2,6 isomers of toluene diisocyanate. Examples of other suitable isocyanates include methylene diphenyl isocyanate (MDI) and MDI/TDI blends.

Additional components suitable for incorporation into foam may be added at various locations in the process in other embodiments. In some embodiments, additives may be added to polyol-PCM blend before addition of the isocyanate. Commonly known additives for foam such as activators, catalysts, stabilizers, colorants, dyes, pigments, chain-extending agents, surface-active agents (i.e., surfactants), fillers, blowing agents, and the like may be added at appropriate locations in the process, as will be known to those of skill in the art. In some embodiments, the additives may be surfactants, catalysts, blowing agents or combinations thereof. In some embodiments, the catalyst may be a tin catalyst, an amine catalyst, or combinations thereof. In some embodiments, the catalyst may be in an amount from about 0.1 to about 1 php. In some embodiments, the amine catalyst may be present in an amount from about 0.05 to about 0.5 php. In some embodiments, the tin catalyst may be present in an amount from about 0.02 to about 0.20 php. In some embodiments, the surfactant is a silicon surfactant. In some embodiments, the surfactant may be present in an amount from about 0.4 to about 1.4 php. In some embodiments, the blowing agent may be water. In some embodiments, the blowing agent is present in an amount from about 1 to about 6 php. In some embodiments, the isocyanate is in an amount from about 40 to about 60 php.

The blowing agent of embodiments herein may be any suitable blowing agent, for example water. Physical blowing agents such as carbon dioxide, acetone, pentane, nucleating gas such as air or nitrogen, or combinations thereof may also be used.

The catalyst of embodiments herein may be any suitable catalyst for use in a reaction to form a foam, and, in some embodiments, the catalyst may be an organotin catalyst. Organotin catalysts are a family of organic tin compounds used as catalysts in flexible polyurethane foam production that help to control the gelation reaction rate, for example, when the blend becomes a gel. The catalyst reacts into the foam product and serves as a cell wall reinforcer so the final foam material will stand up and not collapse. Examples of organotin catalysts include stannous octoate, dibutyltin dilaurate, dibutyltin diacetate, and dibutyltin diethyl hexoate. In an embodiment, stannous octoate may be used as the organotin catalyst when producing conventional foams. In an alternate embodiment dibutyltin dilaurate may be used as the organotin catalyst when producing high resiliency (HR) foams. In an alternate embodiment, the catalyst may be an amine catalyst. These catalysts include amines that balance the gelation and blowing reactions, examples of which include NLIX A-130, NIAX A-1, NIAX A-300, NIAX A-130 by OSI Specialties, a division of Compton Corporation.

As will be readily apparent to one of skill in the art, a wide variety of polyurethane foam formulations incorporating an equally wide variety of components such as polyols and isocyanates may be produced according to the present invention. In some embodiments, the foam may be a flexible polyurethane foam. In some embodiments, the foam may be an open-cell or a partially open-cell polyurethane foam. Additionally, other foams, such as, but not limited to, memory foams, viscoelastic foams, reflex foam, latex foam, slow recovery foam, ground foam, continuous foam, hyper-soft resilient foam, or hyper-soft high airflow viscoelastic foam may be made using the same process. Additionally, bedding products may be made using any of the above described processes.

In some embodiments, the foam may be about 1 inch to about 100 inches thick. In some embodiments, the thickness of the foam may comprise from about 1 inch to about 75 inches, about 1 inch to about 50 inches, about 5 inches to about 100 inches, about 5 inches to about 75 inches, about 5 inches to about 50 inches. Specific examples of thickness of the foam may include about 5 inches, about 6 inches, about 10 inches, about 15 inches, about 20 inches, about 30 inches, about 40 inches, about 45 inches, about 48 inches, about 50 inches, about 75 inches, about 100 inches, or a range between any two of these values.

This invention and embodiments illustrating the method and materials used may be further understood by reference to the following non-limiting examples.

### Example 1

50 php of a wax PCM, MPCM 28D (sold by Microtek), which has a melting point at 28° C. (82° F.) and is micro-encapsulated into a fine powder, was dispersed into a blend of polyols. The polyol blend consisted of 58.5 php of polyol SP-170 (Peterson Chemical Technology), 26.0 php of polyol SP-2744 (Peterson Chemical Technology), 0.5 php of polyol SP-370 (Peterson Chemical Technology), and 12.0 php of polyol SP-238 (Peterson Chemical Technology).

To the blend of 100 php polyol with 50 php PCM was added 1.0 php of silicon surfactant (L-618 from Momentive), 0.2 parts of amine catalyst (Jeffcat ZF-10 from Huntsman), 0.08 php of tin catalyst TCAT-110 from Gulbrandsen and 2.18 php of water.

The total blend was stirred for 30 seconds before the addition of 51.1 php of isocyanate MDI S-7050 from Huntsman. The total blend was then stirred for an additional 15 seconds before pouring into a 14×14×6 inch open mold which was lined with a thin film of polypropylene. The viscous mixture was allowed to free rise in the mold and was completely raised after three minutes and completely filled the mold. The resulting viscoelastic open cell polyurethane foam was allowed to cure for 24 hours before being cut into samples for physical analysis.

The viscoelastic open cell polyurethane foam had a density of 3.98 pounds per cubic foot and felt cooler to the hand compared to equivalent foam which did not contain PCM.

### Example 2

Flexible open cell polyurethane foams having various amounts of microencapsulated PCMs were manufactured using the “one-shot” method. It was found that foams having microencapsulated PCMs in an amount greater than about 10% by weight of the PCM-containing foam adversely affected the exothermic reaction required for foam formation such that the strength and physical properties of the foam were reduced. Furthermore, microencapsulated PCMs in an amount greater than about 10% contributed a diminishing cooling effect to the foam, (i.e. twice the amount of PCM did not make the foam feel twice as cool). Accordingly, foams may include up to about 10% microencapsulated PCM by weight of the PCM-containing foam. About 7% to about 10% microencapsulated PCM by weight of the PCM-containing foam is preferred for the perceived cooling effect that the microencapsulated PCM imparts while not adversely affecting the foaming reaction.

Although the present invention has been described in considerable detail with reference to certain preferred embodiments thereof, other versions are possible. Therefore the spirit and scope of the invention should not be limited to the description and the preferred versions contained within this specification.

1. A cooling cushion comprising a microencapsulated phase change material having a melting point in the range from about −30° C. to about 55° C. and a foam, wherein the phase change material is dispersed within the foam.

2. The cushion of claim 1, wherein the foam comprises viscoelastic foam, polyurethane foam, memory foam, slow recovery foam, ground foam, latex foam, reflex foam, continuous foam, hyper-soft resilient foam, hyper-soft high airflow viscoelastic foam or a combination thereof.

3. The cushion of claim 1, wherein the phase change material comprises a halogenated paraffin having 10 to 22 carbon atoms, 2,2-dimethyl-1,3-propanediol, 2-hydroxymethyl-2-methyl-1,3-propanediol, eicosanic acid, methyl palmitate, a fatty acid ester, a fatty alcohol or a combination thereof.

4. The cushion of claim 1, wherein the phase change material is evenly dispersed throughout the foam.

5. The cushion of claim 1, wherein the phase change material is in an amount of up to about 10% by weight of the foam.

6. A bedding product comprising a microencapsulated phase change material having a melting point in the range from about −30° C. to about 55° C. and a foam, wherein the phase change material is dispersed within the foam.

7. The bedding product of claim 6, wherein the foam comprises viscoelastic foam, polyurethane foam, memory foam, slow recovery foam, ground foam, latex foam, reflex foam, continuous foam, hyper-soft resilient foam, hyper-soft high airflow viscoelastic foam or a combination thereof.

8. The bedding product of claim 6, wherein the phase change material comprises a halogenated paraffin having 10 to 22 carbon atoms, 2,2-dimethyl-1,3-propanediol, 2-hydroxymethyl-2-methyl-1,3-propanediol, eicosanic acid, methyl palmitate, a fatty acid ester, a fatty alcohol or a combination thereof.

9. The bedding product of claim 6, wherein the phase change material is evenly dispersed throughout the foam.

10. The bedding product of claim 6, wherein the phase change material is in an amount of up to about 10% by weight of the foam.

11. A method of making a cooling cushion comprising:
dispersing a microencapsulated phase change material having a melting point in the range from about −30° C. to about 55° C. into a polyol to create a polyol-PCM blend; and
adding an isocyanate to the polyol-PCM blend to form an uncured viscous mixture.

12. The method of claim 11, further comprising mixing additives into the polyol-PCM blend.

13. The method of claim 12, wherein the additive is an activator, a catalyst, a stabilizer, a colorant, a dye, a pigment, a chain-extending agent, a surfactant, a filler, a blowing agent, or a combination thereof.

14. The method of claim 11 further comprising curing the viscous mixture to form a foam.

15. The method of claim 14, wherein the phase change material is in an amount of up to about 10% by weight of the foam.

16. The method of claim 11 further comprising pouring the viscous mixture into a mold.

17. A method of making a cooling cushion comprising reacting a polyol and a microencapsulated phase change material having a melting point in the range from about −30° C. to about 55° C. with an isocyanate.

18. A method of making a cooling cushion comprising continuously pouring polyol, microencapsulated phase change material having a melting point in the range from about −30° C. to about 55° C. and isocyanate together to form a foaming reaction.

19. A method of making a bedding product comprising reacting a polyol and a microencapsulated phase change material having a melting point in the range from about −30° C. to about 55° C. with an isocyanate.

20. A method of making a bedding product comprising dispersing a microencapsulated phase change material having a melting point in the range from about −30° C. to about 55° C. in a polyol to create a polyl-PCM blend and reacting the polyol-PCM blend with an isocyanate to form a viscous mixture.
